(19) United States
(12) Patent Application Publication
(10) Pub. No.: US 2023/0354140 A1
(43) Pub. Date: Nov. 2, 2023

(54) RADIO ACCESS NETWORK NODE, USER EQUIPMENT, CORE NETWORK NODE, SERVER APPLICATION NODE AND METHODS PERFORMED THEREIN

(71) Applicant: Telefonaktiebolaget LM Ericsson (publ), Stockholm (SE)

(72) Inventors: Tomas NYLANDER, Värmdö (SE); Daniel MCGILLIVRAY, Vallda (SE); Roland GUSTAFSSON, Bengtsfors (SE)

(73) Assignee: Telefonaktiebolaget LM Ericsson (publ), Stockholm (SE)

(21) Appl. No.: 17/791,298

(22) PCT Filed: Jan. 10, 2020
(86) PCT No.: PCT/SE2020/050014

§ 371 Date: Jul. 7, 2022

(51) Int. Cl. H04W 36/38; H04W 36/30

(52) U.S. Cl. CPC H04W 36/38; H04W 36/30

(57) ABSTRACT

A method performed by a RAN node (12) for handling a communication in a communication network. The RAN node detects an upcoming event based on 5 whether a condition is fulfilled or not. The condition is related to a connection between the RAN node and a UE (10) served by the RAN node. The RAN node further provides to the UE or an application associated with the UE, an indication of the detected upcoming event.

### TECHNICAL FIELD

Embodiments herein relate to a Radio Access Network (RAN) node, a User Equipment (UE), a Core Network (CN) node, a Server Application (SA) node and methods performed therein. In particular, embodiments herein relate to handling a communication in a communication network.

### BACKGROUND

In a typical communication network, User Equipment (UE), also known as wireless communication devices, mobile stations, stations (STA), terminals, vehicles with wireless devices, and/or wireless devices, communicate via a Radio Access Network (RAN) to one or more core networks belonging to different network operators. The RAN covers a geographical area which is divided into areas or cell areas, with each area or cell area being served by a radio network node, e.g., a Wi-Fi access point or a Radio Base Station (RBS), which in some networks may also be called, for example, a NodeB, eNodeB or a gNodeB. The area or cell area(s) is a geographical area where radio coverage is provided by the radio network node. The radio network node communicates over an air interface operating on radio frequencies with the UE within range of the radio network node.

A Universal Mobile Telecommunications System (UMTS) is a third generation telecommunication network, which evolved from the second generation (2G) Global System for Mobile Communications (GSM). The UMTS Terrestrial Radio Access Network (UTRAN) is essentially a RAN using Wideband Code Division Multiple Access (VVCDMA) and/or High Speed Packet Access (HSPA) for user equipment. In a forum known as the Third Generation Partnership Project (3GPP), telecommunications suppliers propose and agree upon standards for third generation networks and UTRAN specifically, and investigate enhanced data rate and radio capacity. In some RANs, e.g. as in UMTS, several radio network nodes may be connected, e.g., by landlines or microwave, to a controller node, such as a Radio Network Controller (RNC) or a Base Station Controller (BSC), which supervises and coordinates various activities of the plural radio network nodes connected thereto. The RNCs are typically connected to one or more core networks.

Specifications for the Evolved Packet System (EPS) have been completed within the 3GPP and this work continues in the coming 3GPP releases. The EPS comprises the Evolved Universal Terrestrial Radio Access Network (E-UTRAN), also known as the Long Term Evolution (LTE) radio access network, and the Evolved Packet Core (EPC), also known as System Architecture Evolution (SAE) core network. E-UTRAN/LTE is a variant of a 3GPP radio access technology wherein the radio network nodes are directly connected to the EPC core network rather than to RNCs. In general, in E-UTRAN/LTE the functions of an RNC are distributed between the radio network nodes, e.g. eNodeBs in LTE, and the core network. As such, the RAN of an EPS has an essentially “flat” architecture comprising radio network nodes connected directly to one or more core networks, i.e. they are not connected to RNCs.

With the emerging 5G technologies such as New Radio (NR), the use of very many transmit- and receive-antenna elements is of great interest as it makes it possible to utilize beamforming, such as transmit-side and receive-side beamforming. Transmit-side beamforming means that the transmitter can amplify the transmitted signals in a selected direction or directions, while suppressing the transmitted signals in other directions. Similarly, on the receive-side, a receiver can amplify signals from a selected direction or directions, while suppressing unwanted signals from other directions.

Connectivity is of high importance in cases related to e.g. the automotive industry. Autonomous vehicles, i.e. vehicles that support a self-driving mode, may need to be connected to be informed about upcoming events such as interruptions and/or disturbances such as accidents, where control of the vehicle may need to be handed over to a driver or the vehicle may need to be stopped or slowed down.

An autonomous vehicle may be controlled for driving the vehicle along a path or route, and/or for performing any other functions such as measuring or observing the environment or executing operations on objects outside the vehicle. To enable such control, the vehicle is typically equipped with a wireless device which may communicate with a RAN node over radio access points of a communication network. Usually, session continuity assures that connectivity is maintained as the vehicle with the wireless device, moves. I.e. the connectivity session is transferred to radio access points along a route to assure connectivity, which may interrupt or disturb communication leading to a reduced performance of handling a service of the vehicle.

### SUMMARY

An objective of embodiments herein is to provide a mechanism that increase performance of communication of a UE, such as a vehicle, in an efficient manner.

According to an aspect the objective is achieved by providing a method performed by a RAN node for handling a communication in a communication network. The RAN node detects an upcoming event based on whether a condition is fulfilled or not. The condition is related to a connection between the RAN node and a UE served by the RAN node. The RAN node then provides, to the UE or an application associated with the UE, an indication of the detected upcoming event.

According to another aspect the objective is achieved by providing a method performed by a UE for handling a communication in a communication network. The UE receives, from a RAN node or internally, an indication of a detected upcoming event affecting a connection between the RAN node and the UE served by the RAN node. The UE then performs communication taking the indication into account.

According to yet another aspect the objective is achieved by providing a method performed by a CN node for handling a communication in a communication network. The CN node receives, from a RAN node, an indication of a detected upcoming event affecting a connection between the RAN node and a UE served by the RAN node. The CN node then transmits the same or another indication of the detected upcoming event, towards a SA node associated with the UE.

According to still another aspect the objective is achieved by providing a method performed by a SA node, which may also be referred to as application server, for handling a communication in a communication network. The SA node receives, from a CN node, an indication of a detected upcoming event affecting a service provided to a UE served by the SA node. The SA node then provides the service to the UE taking the indication into account or informing the UE of the upcoming event.

According to another aspect of embodiments herein, the objective is achieved by providing a RAN node for handling a communication in a communication network. The RAN node is configured to detect an upcoming event based on whether a condition is fulfilled or not, wherein the condition is related to a connection between the RAN node and a UE served by the RAN node. The RAN node is then configured to provide, to the UE or an application associated with the UE, an indication of the detected upcoming event.

According to still another aspect of embodiments herein, the objective is achieved by providing a UE for handling a communication in a communication network. The UE is configured to receive, from a RAN node or internally, an indication of a detected upcoming event affecting a connection between the RAN node and the UE served by the RAN node. The UE is then configured to perform communication taking the indication into account.

According to yet another aspect of embodiments herein, the objective is achieved by providing a CN node for handling a communication in a communication network. The CN node is configured to receive, from a RAN node, an indication of a detected upcoming event affecting a connection between the RAN node and a UE served by the RAN node. The CN node is then configured to transmit the same or another indication of the detected upcoming event, towards a SA node associated with the UE.

According to another aspect of embodiments herein, the objective is achieved by providing a SA node for handling a communication in a communication network. The SA node is configured to receive, from a CN node, an indication of a detected upcoming event affecting a service provided to a UE served by the SA node. The SA node is then configured to provide the service to the UE, taking the indication into account or informing the UE of the upcoming event.

It is furthermore provided herein a computer program product comprising instructions, which, when executed on at least one processor, cause the at least one processor to carry out the method above, as performed by the RAN node, the UE, the CN node or the SA node, respectively. It is additionally provided herein a computer-readable storage medium, having stored thereon a computer program product comprising instructions which, when executed on at least one processor, cause the at least one processor to carry out the method according to the method above, as performed by the RAN node, the UE, the CN node or the SA node, respectively.

The RAN node or the UE may detect one or more upcoming events based on whether a condition is fulfilled or not. Thus, the UE or an application associated with the UE may be informed about the one or more upcoming events, by the RAN node or internally by the UE. When detected by the RAN node, the RAN node provides an indication of the one or more detected upcoming events to the UE. The providing is performed either directly to the UE or via the CN node and the SA node. By informing the UE of the one or more upcoming events the service for UEs such as connected vehicles is improved and thereby the UE may behave in a more reliable and/or predictable manner and thus the performance of the communication of the UE may be increased in an efficient manner.

### BRIEF DESCRIPTION OF THE DRAWINGS

Examples of embodiments herein are described in more detail with reference to attached drawings in which:

FIG. 1 is a schematic block diagram depicting some embodiments herein;

FIG. 2 is a combined signalling scheme and flowchart depicting embodiments herein;

FIG. 3 is a combined signalling scheme and flowchart depicting embodiments herein;

FIG. 4 is a flowchart depicting embodiments of a method performed by a RAN node in the communications network;

FIG. 5 is a flowchart depicting embodiments of a method performed by a UE in the communications network;

FIG. 6 is a flowchart depicting embodiments of a method performed by a CN node in the communications network;

FIG. 7 is a flowchart depicting embodiments of a method performed by a SA node in the communications network;

FIG. 8 is a flowchart depicting some embodiments herein;

FIG. 9 is a flowchart depicting some embodiments herein;

FIG. 10 is a flowchart depicting some embodiments herein;

FIG. 11 is a schematic block diagram illustrating a RAN node according to embodiments herein;

FIG. 12 is a schematic block diagram illustrating a UE according to embodiments herein;

FIG. 13 is a schematic block diagram illustrating a CN node according to embodiments herein;

FIG. 14 is a schematic block diagram illustrating a SA node according to embodiments herein;

FIG. 15 is a telecommunication network connected via an intermediate network to a host computer in accordance with some embodiments;

FIG. 16 is a host computer communicating via a base station with a user equipment over a partially wireless connection in accordance with some embodiments;

FIG. 17 is methods implemented in a communication system including a host computer, a base station and a user equipment in accordance with some embodiments;

FIG. 18 is methods implemented in a communication system including a host computer, a base station and a user equipment in accordance with some embodiments;

FIG. 19 is methods implemented in a communication system including a host computer, a base station and a user equipment in accordance with some embodiments; and

FIG. 20 is methods implemented in a communication system including a host computer, a base station and a user equipment in accordance with some embodiments.

### DETAILED DESCRIPTION

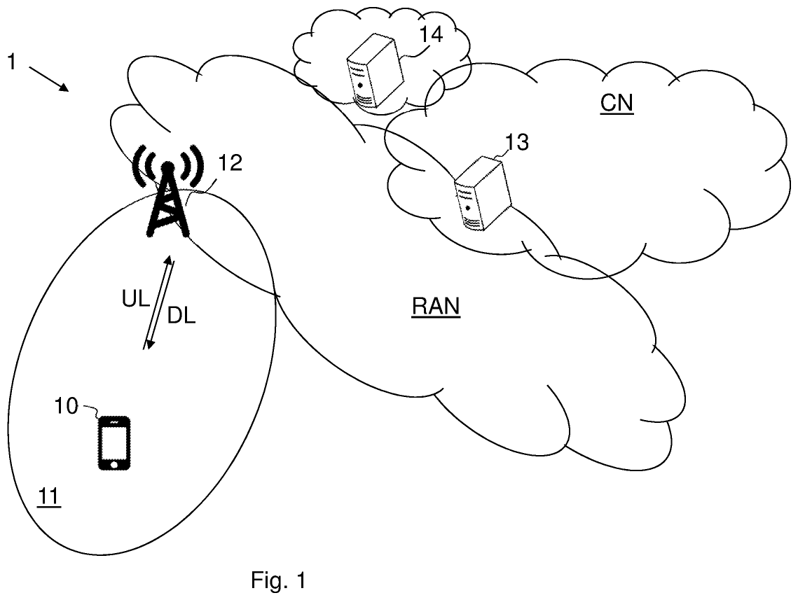

Embodiments herein relate to communication networks in general. FIG. 1 is a schematic overview depicting a wireless communications network, e.g. a communications network 1. The communications network 1 comprises one or more Radio Access Networks (RAN) and one or more Core Networks (CN). The communications network 1 may use one or a number of different technologies. Embodiments herein relate to recent technology trends that are of particular interest in a New Radio (NR) context, however, embodiments are also applicable in further development of existing wireless communications systems such as e.g. LTE or Wideband Code Division Multiple Access (WCDMA).

In the communications network 1, a UE 10, exemplified herein as a vehicle may be a wireless device, a mobile station, a non-access point (non-AP) station (STA), a STA and/or a wireless terminal, is comprised and may communicate via e.g. one or more Access Networks (AN), e.g. RAN, to one or more CNs. It should be understood by the skilled in the art that “UE” is a non-limiting term which means any terminal, wireless communications terminal, user equipment, narrowband internet of things (NB-IoT) device, Machine Type Communication (MTC) device, Device to Device (D2D) terminal, or node e.g. smart phone, laptop, mobile phone, sensor, relay, mobile tablets or even a small base station capable of communicating using radio communication with a radio network node within an area served by the radio network node.

The communication network 1 comprises a RAN node 12 providing radio coverage over a geographical area, a first service area, of a first radio access technology (RAT), such as NR, LTE, or similar. The RAN node 12 may be a transmission and reception point such as an access node, an access controller, a base station, e.g. a radio base station such as a gNodeB (gNB), an evolved Node B (eNB, eNode B), a NodeB, a base transceiver station, a radio remote unit, an Access Point Base Station, a base station router, a Wireless Local Area Network (WLAN) access point or an Access Point Station (AP STA), a transmission arrangement of a radio base station, a stand-alone access point or any other network unit or node capable of communicating with a wireless device within the area served by the RAN node 12 depending e.g. on the first radio access technology and terminology used. The RAN node 12 is serving the UE 10 and may be referred to as a serving radio network node wherein the service area may be referred to as a serving cell, and the serving network node communicates with the UE 10 in form of DL transmissions to the UE 10 and UL transmissions from the UE 10. It should be noted that a service area may be denoted as cell, beam, beam group or similar to define an area of radio coverage.

The communication network 1 further comprises a core network node 13 such as a mobility management entity (MME), for example in an implementation of LTE or an access & mobility management function (AMF) node, a service capability exposure function (SCEF) node or a network exposure function (NEF) node in an implementation of 5G.

The communication network 1 comprises a Server Application (SA) node 14, such as an application server (AS). The SA node 14 may be 14 may be located outside the core network domain, e.g. in a cloud environment. And the SA node 14 may be a server or a node with an application that waits for requests from other applications and responds to them, thus providing a service upon their request.

Continuous connectivity may not be guaranteed in communication networks, due to e.g.: physics; areas with no or bad coverage from a serving mobile network; congestion in radio cells or when changing serving mobile network. Bad or lost connectivity may have a severe effect on the performance of the application and/or the UE. However, if a UE, such as a vehicle, or application related to the UE, is made aware of upcoming interruptions or disturbances, the UE 10 may be able to mitigate and/or reduce impact of the interruptions or disturbances. For example, in case a vehicle is aware of an upcoming interruption, the vehicle may download needed information for the path in advance, slow down in a smoother way to avoid hard braking, or select another route.

Embodiments herein thus introduce embodiment informing the UE, e.g. the vehicle, or the application related to the UE, about one or more upcoming interruptions and/or disturbances. It is herein e.g. proposed a method for handling communication in the communication network 1. The RAN node 12 detects upcoming events and provides an indication of the detected upcoming events to the UE 10. The indication of the detected upcoming events is transmitted directly to the UE 10 or may be transmitted via the CN node 13 and SA node 14 to the UE 10. An advantage with the embodiments herein is thus the enabling of better service for the UE 10, such as connected vehicles, to enable the UE to perform an action to mitigate impact of the upcoming interruptions and/or disturbances.

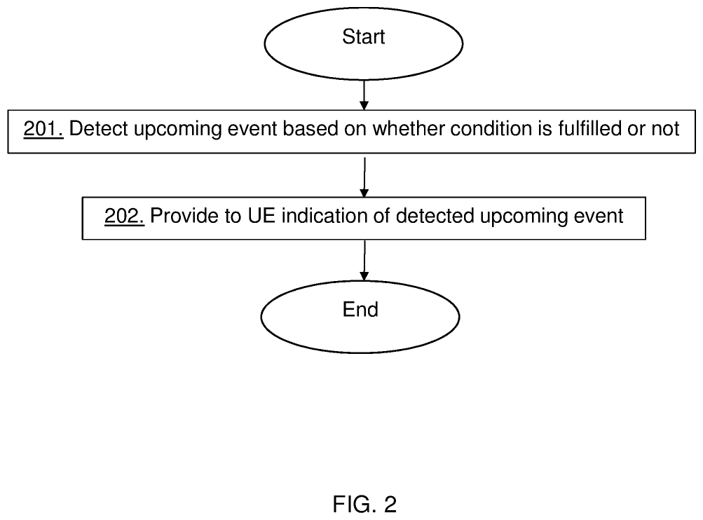

The method actions performed by the RAN node 12 for handling the communication in the communication network according to some embodiments will now be described with reference to a flowchart depicted in FIG. 2. The actions do not have to be taken in the order stated below, but may be taken in any suitable order.

Action 201. The RAN node 12 detects the upcoming event based on whether the condition is fulfilled or not. The condition is related to the connection between the RAN node and the UE 10 served by the RAN node 12. The detected upcoming event may be related to change of communication performance and may comprise one or more of the following: initiating a handover for the UE; a loss of connectivity; a change of data rate; when a signal-to-noise ratio is below a threshold value; no suitable target cell e.g. for handover; a change to a target cell that belongs to another RAN or belongs to another mobile network.

Action 202. The RAN node 12 provides to the UE 10 or the application associated with the UE 10, the indication of the detected upcoming event. The indication may be transmitted to the UE 10 and/or the indication may be transmitted to the CN node 13. According to some embodiments the indication may be transmitted to the UE 10, using a Radio Resource Control (RRC) message.

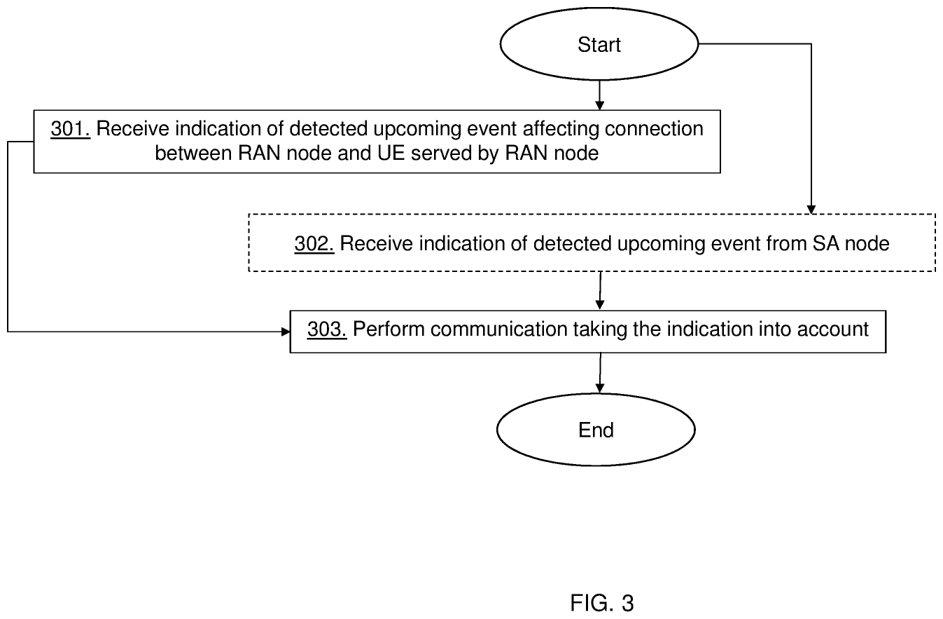

The method actions performed by the UE 10 for handling the communication in the communication network according to some embodiments will now be described with reference to the flowchart depicted in FIG. 3. The actions do not have to be taken in the order stated below, but may be taken in any suitable order. Actions performed in some embodiments are marked with dashed boxes.

Action 301. The UE 10 receives, from the RAN node 12 or internally, the indication of the detected upcoming event affecting the connection between the RAN node 12 and the UE 10 served by the RAN node 12. The indication may be received using the RRC message, from the RAN node 12. It should be noted that the indication may be received at a modem of the UE 10 and forwarded over an Application Programming Interface (API) to an operating system (OS) of the UE 10. The OS of the UE may thus be informed of the indication over an API and the OS may inform the application associated with the UE 10 of the indication. Thus, the indication of the detected upcoming event may be received by a Client Application of the UE 10.

Action 302. According to some embodiments the UE 10 receives, from the SA node 14 the indication of the detected upcoming event.

Action 303. The UE 10 then performs communication taking the indication into account. The UE may e.g. perform communication taking the indication into account by adjusting behaviour of the UE 10 based on the indication. E.g. the UE may change path of movement to increase communication performance, change data rate, download needed information before interruption (i.e. increase data rate) or similar.

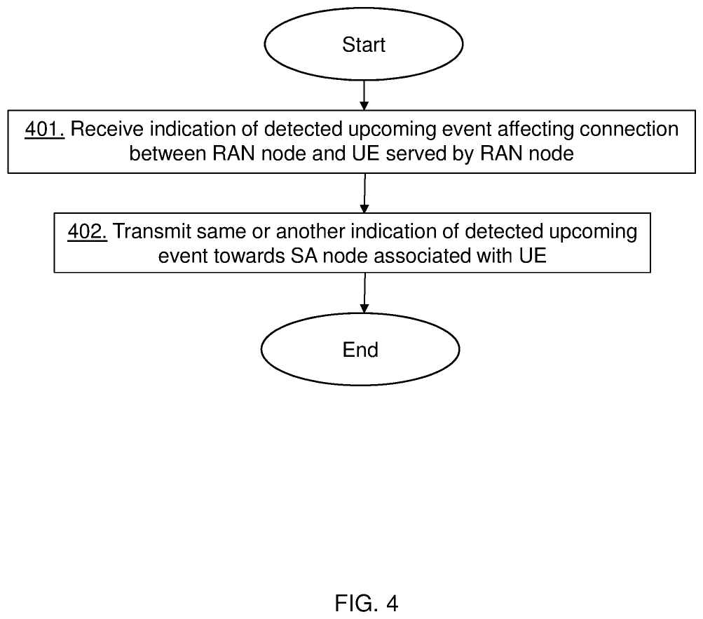

The method actions performed by the CN node 13 for handling the communication in the communication network according to some embodiments will now be described with reference to a flowchart depicted in FIG. 4. The actions do not have to be taken in the order stated below, but may be taken in any suitable order.

Action 401. The CN node 13 receives, from the RAN node 12, the indication of the detected upcoming event affecting the connection between the RAN node 12 and the UE 10 served by the RAN node 12.

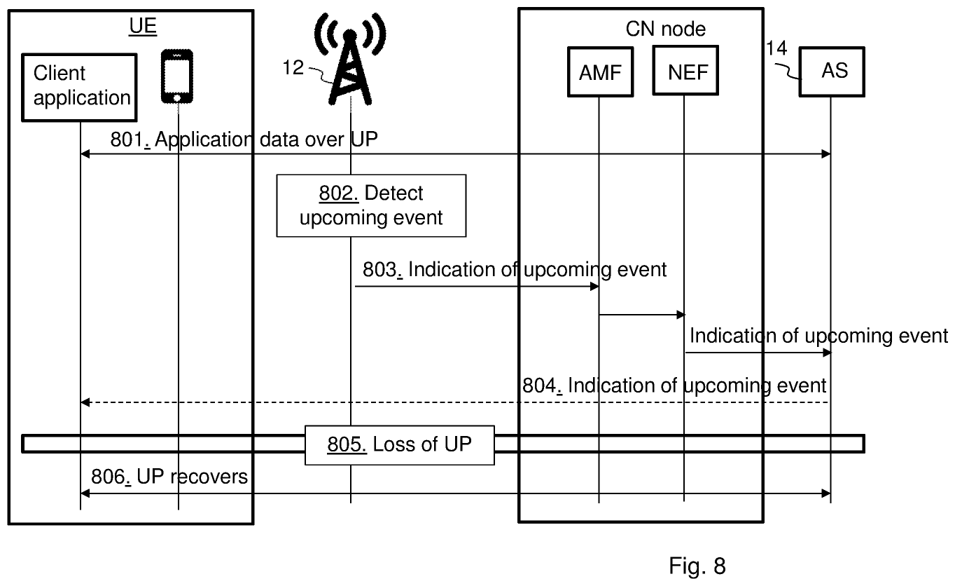

Action 402. The CN node 13 then transmits the same or another indication of the detected upcoming event, towards the SA node 14 associated with the UE 10. The other indication may be e.g. the same indication that has been modified or converted. Thus, the CN node may forward the indication or create and transmit the other indication to the SA node 14. The CN node 13 may adjust the indication based on other factors, such as subscriber profile, quality of service level, location etc. The CN node 13 may improve e.g. convert, reinforce or decorate the indication so the indication may contain additional information, or formats etc., resulting in further reduction of the impact of any interrupts on the user plane. It should be noted that the CN node 13 may be a distributed node comprising a number of CN nodes such as an AMF node and a NEF node or a MME node and the SCEF node as disclosed in FIGS. 8-10.

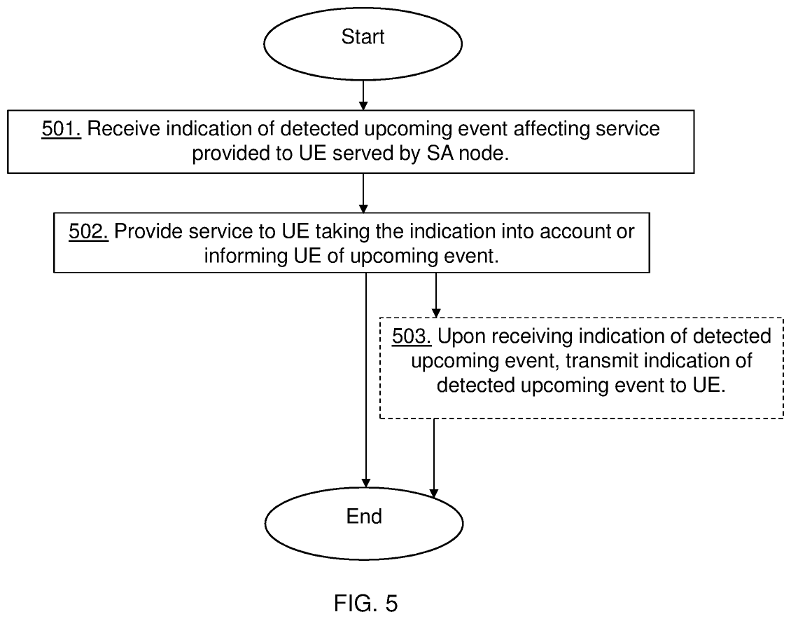

The method actions performed by the SA node 14 for handling the communication in the communication network according to some embodiments will now be described with reference to a flowchart depicted in FIG. 5. The actions do not have to be taken in the order stated below, but may be taken in any suitable order. Actions performed in some embodiments are marked with dashed boxes.

Action 501. The SA node 14 receives, from the CN node 13, the indication of the detected upcoming event affecting the service provided to the UE 10 served by the SA node 14.

Action 502. Upon receiving the indication of a detected upcoming event, the SA node 14 may transmit the indication of the detected upcoming event, to the UE, thus informs the UE 10 of the upcoming event.

Action 503. The SA node 14 provides the service to the UE 10 taking the indication into account. The SA node 14 may thus handle data rate of the service e.g. reduce the rate in case of an upcoming interruption or push down a different path or increase data rate before the event.

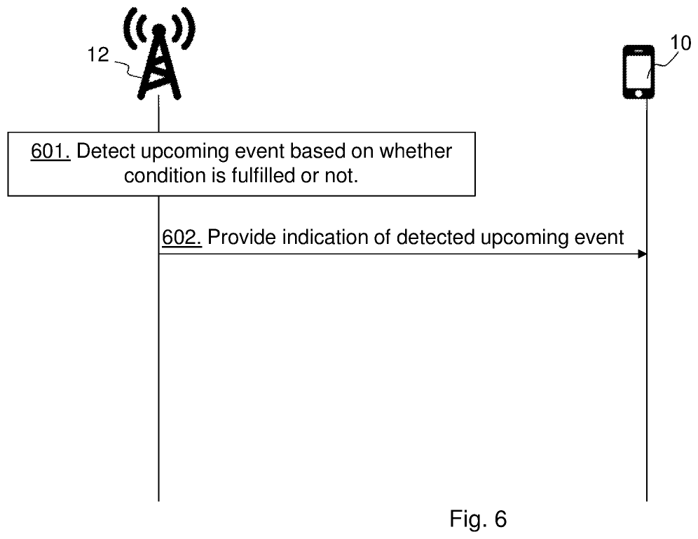

FIG. 6 is a combined flowchart and signalling scheme according to embodiments herein for handling a communication in the communication network 1.

Action 601. Upcoming events, such as events related to impact connection to the UE 10 e.g. interruptions and/or disturbances of the connection, are detected by the RAN node 12 based on whether a condition is fulfilled or not. The condition is related to a connection between the RAN node 12 and the UE 10 served by the RAN node 12. The interruption or disturbance may e.g. be that a handover needs to be initiated, that a desired quality of service (QoS) is jeopardized/cannot be maintained, buffers exceed a threshold, or that a signal-to-noise ratio is below a threshold value. When the condition is fulfilled, the UE 10 may be instructed by the RAN node 12 to perform measurements in the network to find out the network conditions and transmit the measurements, in form of one or more measurement reports, to the RAN node 12. The RAN node 12 may then analyze the measurement reports to confirm any upcoming events. Thus, the RAN node 12 detects the upcoming event based on whether the condition is fulfilled or not.

Action 602. The RAN node 12 then provides e.g. transmits to the UE 10, an indication of the detected upcoming event. For example, the RAN node 12 may analyze the one or more measurement reports from the UE 10. Based on the analysis the RAN node 12 may decide what further actions that may need to be taken. The further action may be to provide the indication of the upcoming event, to the UE 10. It is advantageous that the UE 10 is informed of the upcoming event at an early stage so that the UE 10 can handle the event, e.g. perform communication, before the event occurs. The UE 10 may be provided, i.e. informed, of the indication of the upcoming event by the RAN node 12. The information or indication of the upcoming event may be provided directly to the UE using a Radio Resource Control (RRC) message. The RAN node 12 thus provides to the UE 10 or an application associated with the UE 10, the indication of the detected upcoming event. The providing may be performed either directly to the UE 10 or via the CN node 13 and the SA node 14.

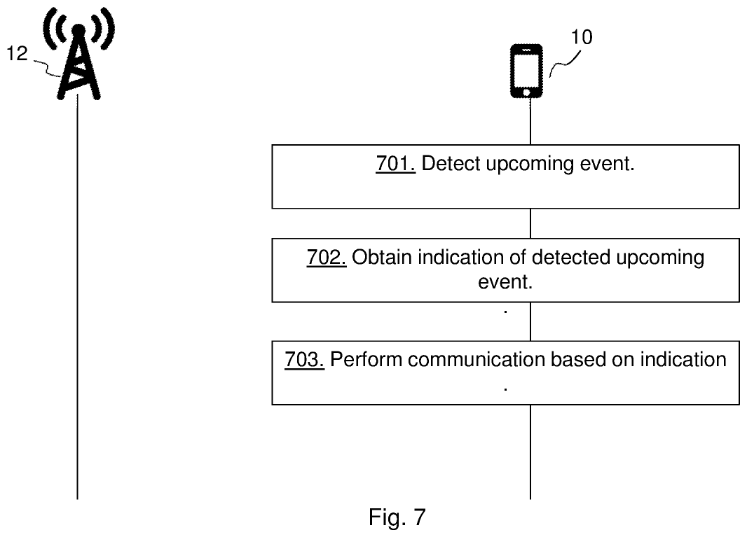

FIG. 7 is a combined flowchart and signalling scheme according to some embodiments herein for handling a communication in the communication network 1.

Action 701. Upcoming events, such as interruptions and/or disturbances may be detected by the UE 10. E.g. the UE may measure signal strength or quality as well as determine whether certain condition(s) are fulfilled such as event for handover or similar and may thus determine and/or create the indication of the detected upcoming event affecting the connection between the RAN node 12 and the UE 10.

Action 702. The UE 10 may be provided, i.e. informed, of the event internally. The UE 10 is provided of the upcoming event internally by e.g. obtaining, such as receiving, the indication at the application through an operating system of the UE 10 from a modem of the UE 10.

Action 703. The UE 10 then performs an action relating to communication taking the indication into account. E.g. change path or speed for improve communication performance, or change data rate of communication based on the indication.

Embodiments herein such as mentioned above will now be further described and exemplified. The text below is applicable to and may be combined with any suitable embodiment described above.

Current mobility functions normally work in the way that a UE is instructed to provide measurements of the radio environment when the serving cell becomes bad, e.g. below a certain threshold. I.e. the UE 10 starts sending measurement reports, then the serving RAN node 12 selects a suitable target cell based on the measurement report, and other configured criteria, to initiate a handover (HO) when a threshold indicates that a HO needs and/or should be performed. There may be other types of measurement reports, e.g. continuous reports etc. It may also be a case where the measurements indicate that the serving cell becomes bad and no target cells exist which may result in loss of connection/communication.

The above mechanisms may be complemented with additional actions taken by the RAN node 12 based on further analysis of the radio and network condition. Examples of this are described below:

1. If the one or more measurement reports indicate that the HO may need to be initiated, e.g. a declining signal from the serving cell and improved signal from a certain cell e.g. a target cell, then based on an additional threshold, new or based on an offset from the HO trigger threshold, the RAN 12 may initiate an indication about upcoming HOs which is an example of an upcoming event.
a. This indication may be more precise if additional analysis at the RAN node 12 is performed and a later trigger is used for the notification, i.e. for a HO the source, e.g. serving, the RAN node 12 may query the target node for resources, either via the CN node 13 or using the direct communication between RAN nodes. The indication about the upcoming HO event may be initiated when a reply from the target radio node is received. However, this later indication may give the application less time to react.

2. If the analysis of the one or more measurement reports indicates that potential target cell belongs to another communication network, then:
a. If HO is configured to be used between the networks, similar actions as described above for 1 applies.
b. If not HO is configured to be used between the networks, an improved service continuity may be supported through cooperation between communication networks, e.g. they are configured to be equivalent Public Land Mobile Networks (PLMNs) and may use the Release with Redirect (RwR) function to drop connection at certain threshold and send information to the UE 10 about frequency bands in the target network. Then a notification may be initiated based on a threshold, new or based on offset from the RwR trigger threshold.

3. If the analysis of the one or more measurement reports indicates that there is no potential target cell, then the RAN node 12 may notify about an event such as an upcoming loss of connectivity. This may be based on the threshold, new or based on an offset from the HO or RwR trigger threshold.

4. If the analysis of the one or more measurement reports indicates that a target cell exists but with a different radio type i.e. a second RAT, e.g. LTE to NR, E-UTRA, UTRA or GSM/EDGE, then the RAN node 12 initiates the indication, e.g. notification, about upcoming inter system HO with information about a larger interrupt compared to a regular HO.

The indication may then be sent using an RRC message, e.g. a new RRC message (notification) or included as a parameter in an existing RRC message, e.g. additional info in RRC re-configuration message. The RRC message would then end up in the modem part of the UE 10, the modem part would then need an API to inform the Operating system (OS) of the UE 10, and furthermore the OS would need an API to inform the application.

Alternative or in combination with informing using RRC, the communication network may inform an application using the exposure functions of a CN node such as a Service Capability Exposure Function (SCEF) node and/or Network Exposure Function (NEF) node. In this case the RAN node 12 sends a message to a CN node such as a Mobility Management Entity (MME) and/or Access and Mobility Management Function (AMF), which creates a message and optionally includes a description of the impact, e.g. expected interrupt duration, or loss of coverage, and sends this message to the SCEF/NEF. The SCEF sends a message to the SA node 14, so the application may prepare itself and/or its clients for the impact. Potentially the information may be sent to/via an application enabler platform. The message sent from the RAN node 12 to the CN node 13, sent over S1/N2 reference points i.e. S1 is for 4G(LTE) and N2 is for NR (5G), may either be a new S1/N2 message or be included in an existing S1/N2 message. Another alternative for transferring this information from the RAN node 12 to the application may be to send the information to the Operation and Maintenance (O&M) system, and have the information conveyed to the application from the O&M system, and potentially use analytical functionality in the O&M system.

In the flowcharts below in FIGS. 8-10, the use of S1/N2 messages and RRC messages are exemplified.

FIG. 8 illustrates a combined flowchart and signal scheme according to some embodiments herein. The providing of the indication of the upcoming event to the UE 10 is in FIG. 8 performed to the UE 10 via the CN node 13 and the SA node 14.

Action 801. The UE 10 is connected to the mobile network and the client application and server application node 14 transmits data over a User Plane (UP).

Action 802. Based on measurements or measurement reports, the RAN node 12 detects an upcoming event, e.g. a potential loss, interruption or disturbance of UP due to a predicted handover situation, due to bad coverage, low signal to noise ratio (SNR) and non-existing target cell.

Action 803. The RAN node 12 sends the indication via the CN 13 to the SA node 14, e.g. the server part of the application. The indication is to inform the application of the upcoming event, e.g. the potential loss, interruption, or disturbance of the UP. The indication may be an indication of upcoming event, e.g. an index of a table or similar.

Action 804. Optionally the SA node 14, i.e. the server part of the application, may send the/an indication of the upcoming event, e.g. the potential loss of UP, to the client part of the application at the UE 10. The indication may be an indication of upcoming event, e.g. the index or similar. It should be noted that the indication may be received at a modem of the UE 10 and forwarded over an Application Programming Interface (API) to an operating system (OS) of the UE 10. The OS of the UE 10 may thus be informed of the indication over an API and the OS may inform the application associated with the UE 10 of the indication.

Action 805. The UP is lost.

Action 806. UP recovers as either due to the mobility procedure, e.g. handover or tracking area update, is performed or the UE 10, e.g. the vehicle, comes into an area with a network coverage.

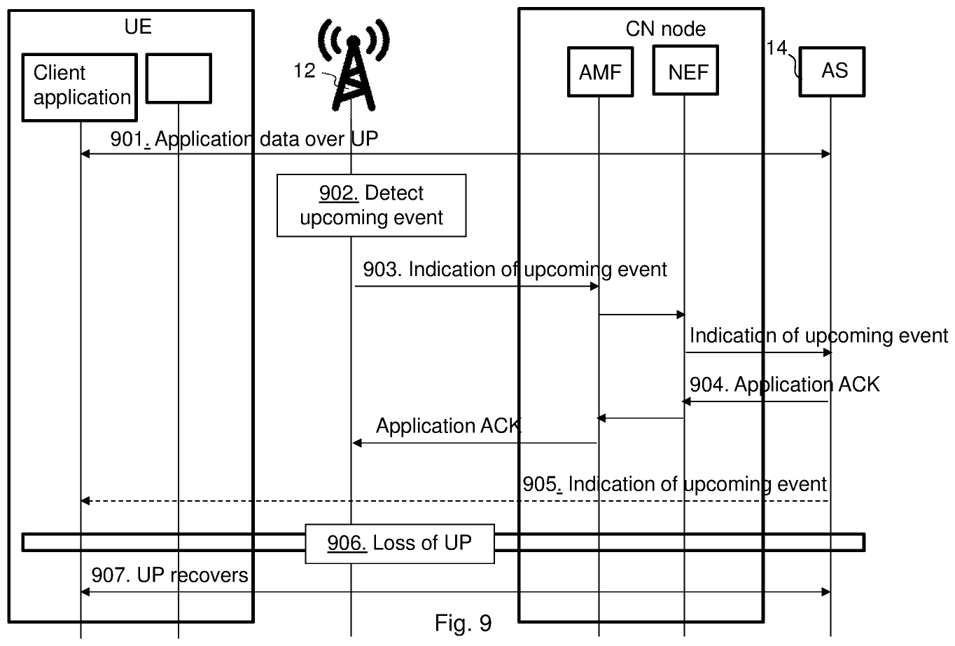

FIG. 9 illustrates a combined flowchart and signal scheme according to some embodiments herein. The actions are the same as in FIG. 8 except for that an Acknowledge (ACK) is added in action 904.

Action 901. The UE 10 is connected to the communication network 1 and the client application and server application 14 transmits data over the User Plane (UP).

Action 902. Based on measurements or measurement reports, the RAN node 12 detects the upcoming event, e.g. a potential loss of UP due to a predicted handover situation, due to bad coverage and non-existing target cell.

Action 903. The RAN node 12 sends the indication via the CN 13 to the SA node 14, e.g. the server part of the application. The indication is to inform the application of the upcoming event, e.g. the potential loss of the UP.

Action 904. When the server part of the application receives the indication from the RAN node 12, via the CN node 13, the SA node 14 may confirm that there is an upcoming event may then send an application acknowledge (ACK) to the RAN node 12 via the CN node 13 indicating to the RAN node 12 to e.g. perform the handover.

Action 905. Optionally the SA node 14, i.e. the server part of the application, may send the indication of the upcoming event, e.g. the potential loss of UP, to the client part of the application at the UE 10.

Action 906. The UP is lost.

Action 907. UP recovers as either due to the mobility procedure, e.g. handover or tracking area update, is performed or the UE 10, e.g. the vehicle, comes into an area with network coverage.

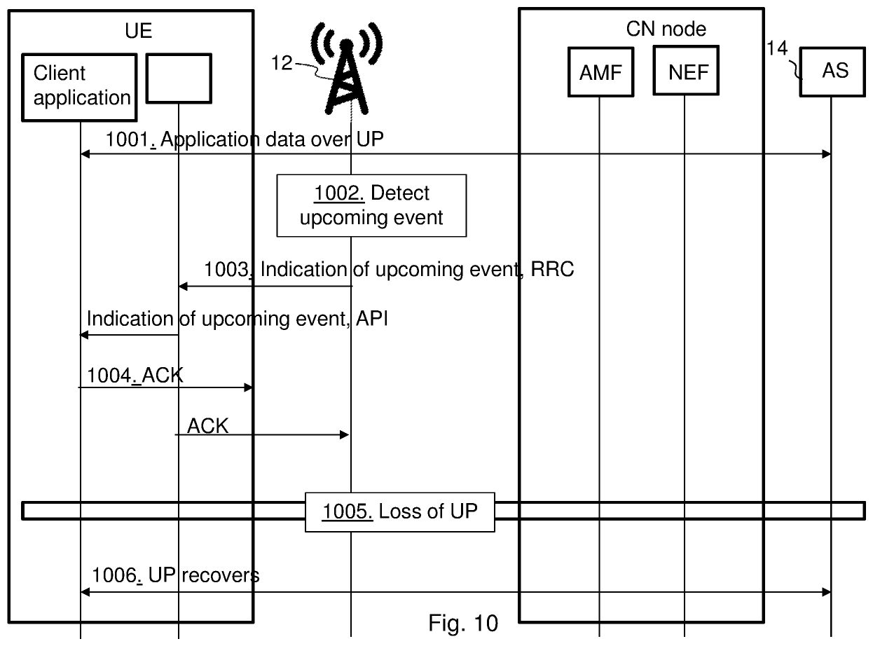

FIG. 10 illustrates a combined flowchart and signal scheme according to some embodiments herein. The providing of the indication of the upcoming event is in FIG. 10 performed directly to the UE 10 using an RRC message.

Step 1001. The UE 10 is connected to the mobile network and client application and server application 14 transmits data over the User Plane (UP).

Step 1002. Based on measurements or measurement reports, the RAN node 12 detects the upcoming event, e.g. a potential loss of UP due to a predicted handover situation, due to bad coverage and/or non-existing target cell.

Step 1003. The RAN node 12 sends the indication, over RRC signalling, from the RAN node 12 to the UE 10. The indication is to inform the client application at the UE of the detected upcoming event, e.g. a potential loss of the UP. The indication may then be transferred to the client part of the application.

Step 1004. The client part of the application may then acknowledge (ACK) reception of the indication to RAN node 12.

Step 1005. The UP is lost.

Step 1006. UP recovers as either due to the mobility procedure, e.g. handover or tracking area update is performed or the UE 10, e.g. the vehicle, comes into an area with network coverage.

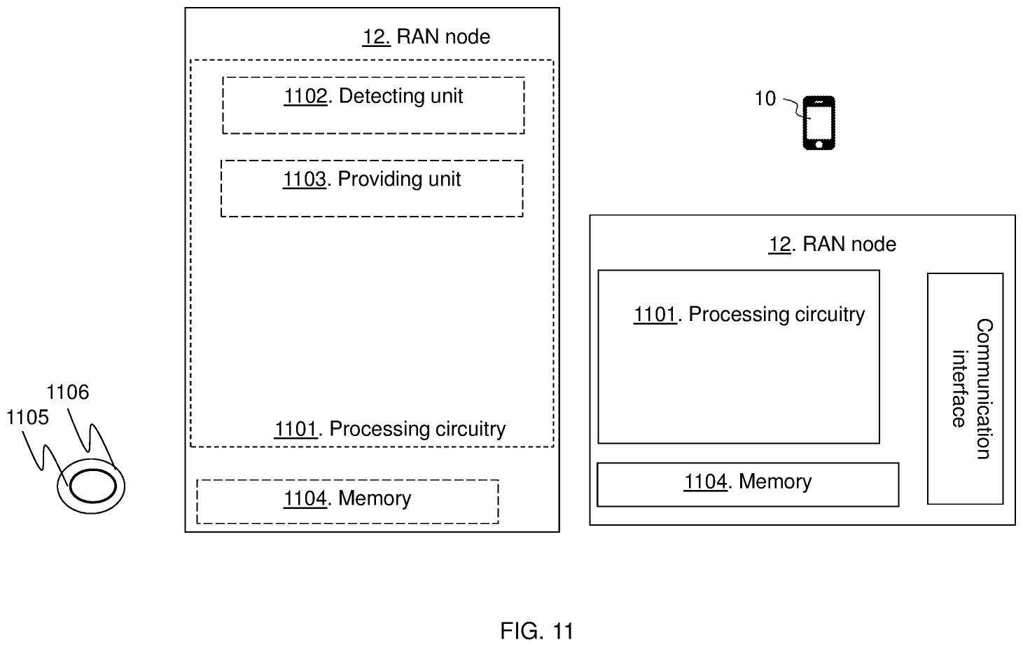

FIG. 11 is a block diagram depicting the RAN node 12 for handling the communication in the communication network according to embodiments herein.

The RAN node 12 may comprise processing circuitry 1101, e.g. one or more processors, configured to perform the methods herein.

The RAN node 12 may comprise a detecting unit 1102. The RAN node 12, the processing circuitry 1101, and/or the detecting unit 1102 is configured to detect the upcoming event based on whether the condition is fulfilled or not, wherein the condition is related to the connection between the RAN node 12 and the UE 10 served by the RAN node 12. The detected upcoming event may comprise one or more of the following: initiating a handover for the UE; a loss of connectivity; a change of data rate; when a signal-to-noise ratio is below a threshold value; or a change to a target cell that belongs to another RAN.

The RAN node 12 may comprise a providing unit 1103. The RAN node 12, the processing circuitry 1101, and/or the providing unit 1103 is configured to provide to the UE 10 or the application associated with the UE 10, the indication of the detected upcoming event. The RAN node 12, the processing circuitry 1101, and/or the providing unit 1103 may be configured to provide the indication by transmitting the indication to the UE 10 e.g. in an RRC message to the UE. The RAN node 12, the processing circuitry 1101, and/or the providing unit 1103 may be configured to provide the indication by transmitting the indication to the CN node 13.

The RAN node 12 further comprises a memory 1104. The memory 1104 comprises one or more units to be used to store data on, such as radio signals, events, indications, data such as services, configuration, input/output data, metadata, etc. and applications to perform the methods disclosed herein when being executed, and similar. The RAN node 12 may further comprise a communication interface comprising e.g. one or more antenna or antenna elements.

The methods according to the embodiments described herein for the RAN node 12 are respectively implemented by means of e.g. a computer program product 1105 or a computer program, comprising instructions, i.e., software code portions, which, when executed on at least one processor, cause the at least one processor to carry out the actions described herein, as performed by the RAN node 12. The computer program product 1105 may be stored on a computer-readable storage medium 1106, e.g. a disc, a universal serial bus (USB) stick or similar. The computer-readable storage medium 1106, having stored thereon the computer program product, may comprise the instructions which, when executed on at least one processor, cause the at least one processor to carry out the actions described herein, as performed by the RAN node. In some embodiments, the computer-readable storage medium may be a transitory or a non-transitory computer-readable storage medium.

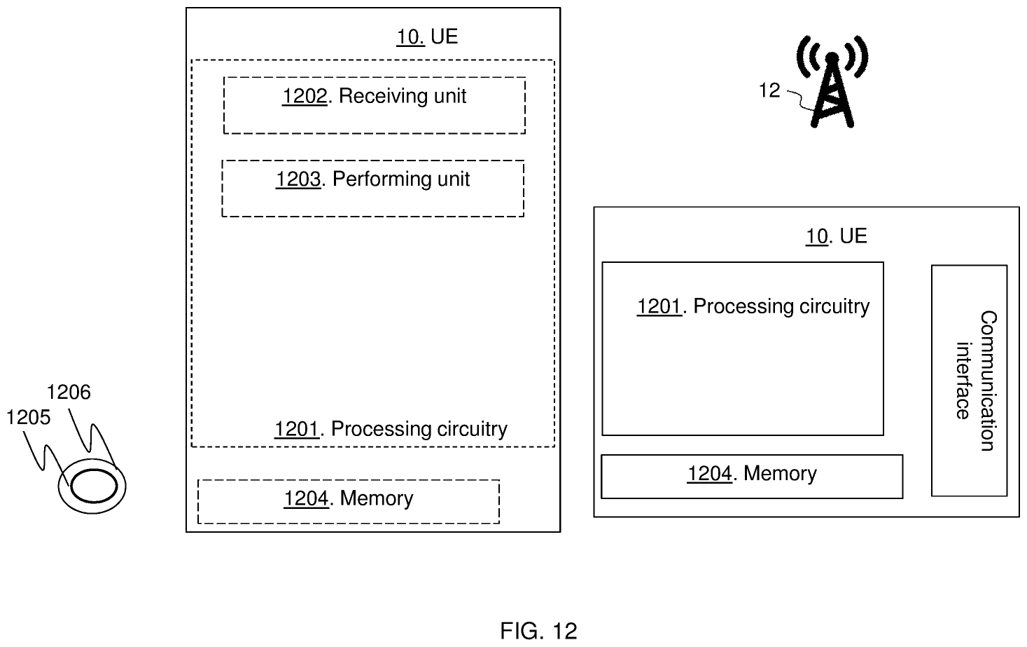

FIG. 12 is a block diagram depicting the UE 10 for handling the communication in the communication network 1 according to embodiments herein.

The UE 10 may comprise processing circuitry 1201, e.g. one or more processors, configured to perform the methods herein.

The UE 10 may comprise a receiving unit 1202. The UE 10, the processing circuitry 1201, and/or the receiving unit 1202 is configured to receive, from the RAN node 12 or internally, the indication of the detected upcoming event affecting the connection between the RAN node 12 and the UE 10 served by the RAN node 12. The UE 10, the processing circuitry 1201, and/or the receiving unit 1202 may be configured to receive the indication in an RRC message, from the RAN node 12.

The UE 10 may comprise an OS, an API, and an application, and the OS may be configured to inform the application of the indication via the API. The UE may comprises a client application and the client application may be configured to receive the indication of the detected upcoming event. The indication of the detected upcoming event may be received by the Client Application of the UE 10. The OS of the UE 10 may be informed of the indication over the API and wherein the OS may inform the application of the indication. The UE 10, the processing circuitry 1201, and/or the receiving unit 1202 may be configured to receive, from the SA node 14, the indication of the detected upcoming event via the RAN node 12.

The UE 10 may comprise a performing unit 1203. The UE 10, the processing circuitry 1201, and/or the performing unit 1203 is configured to perform communication taking the indication into account. The UE 10, the processing circuitry 1201, and/or the performing unit 1203 may be configured to perform the communication taking the indication into account by adjusting behaviour of the UE based on the indication.

The UE 10 further comprises a memory 1204. The memory 1204 comprises one or more units to be used to store data on, such as radio signals, events, indication, data rate, paths, data such as services, configuration, input/output data, metadata, etc. and applications to perform the methods disclosed herein when being executed, and similar. The UE 10 may further comprise a communication interface comprising e.g. one or more antenna or antenna elements.

The methods according to the embodiments described herein for the UE 10 are respectively implemented by means of e.g. a computer program product 1205 or a computer program, comprising instructions, i.e., software code portions, which, when executed on at least one processor, cause the at least one processor to carry out the actions described herein, as performed by the UE 10. The computer program product 1205 may be stored on a computer-readable storage medium 1206, e.g. a disc, a USB stick or similar. The computer-readable storage medium 1206, having stored thereon the computer program product, may comprise the instructions which, when executed on at least one processor, cause the at least one processor to carry out the actions described herein, as performed by the UE 10. In some embodiments, the computer-readable storage medium may be a transitory or a non-transitory computer-readable storage medium.

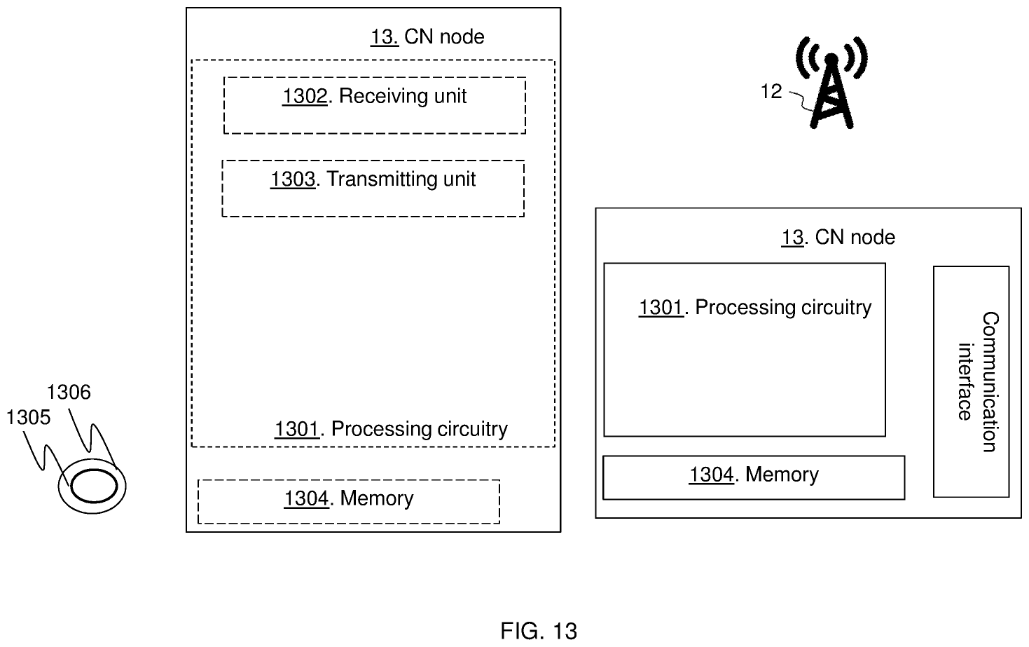

FIG. 13 is a block diagram depicting the CN node 13 for handling a communication in a communication network according to embodiments herein.

The CN node 13 may comprise processing circuitry 1301, e.g. one or more processors, configured to perform the methods herein.

The CN node 13 may comprise a receiving unit 1302. The CN node 13, the processing circuitry 1301, and/or the receiving unit 1302 is configured to receive, from the RAN node 12, the indication of the detected upcoming event affecting the connection between the RAN node and the UE 10 served by the RAN node.

The CN node 13 may comprise a transmitting unit 1303. The CN node 13, the processing circuitry 1301, and/or the transmitting unit 1303 is configured to transmit the same or another indication of the detected upcoming event, towards the SA node 14 associated with the UE 10.

The CN node 13 further comprises a memory 1304. The memory 1304 comprises one or more units to be used to store data on, such as radio signals, events, indication, data such as services, configuration, input/output data, metadata, etc. and applications to perform the methods disclosed herein when being executed, and similar. The CN node 13 may further comprise a communication interface comprising e.g. one or more antenna or antenna elements.

The methods according to the embodiments described herein for the CN node 13 are respectively implemented by means of e.g. a computer program product 1305 or a computer program, comprising instructions, i.e., software code portions, which, when executed on at least one processor, cause the at least one processor to carry out the actions described herein, as performed by the CN node 13. The computer program product 1305 may be stored on a computer-readable storage medium 1306, e.g. a disc, a USB stick or similar. The computer-readable storage medium 1306, having stored thereon the computer program product, may comprise the instructions which, when executed on at least one processor, cause the at least one processor to carry out the actions described herein, as performed by the CN node 13. In some embodiments, the computer-readable storage medium may be a transitory or a non-transitory computer-readable storage medium.

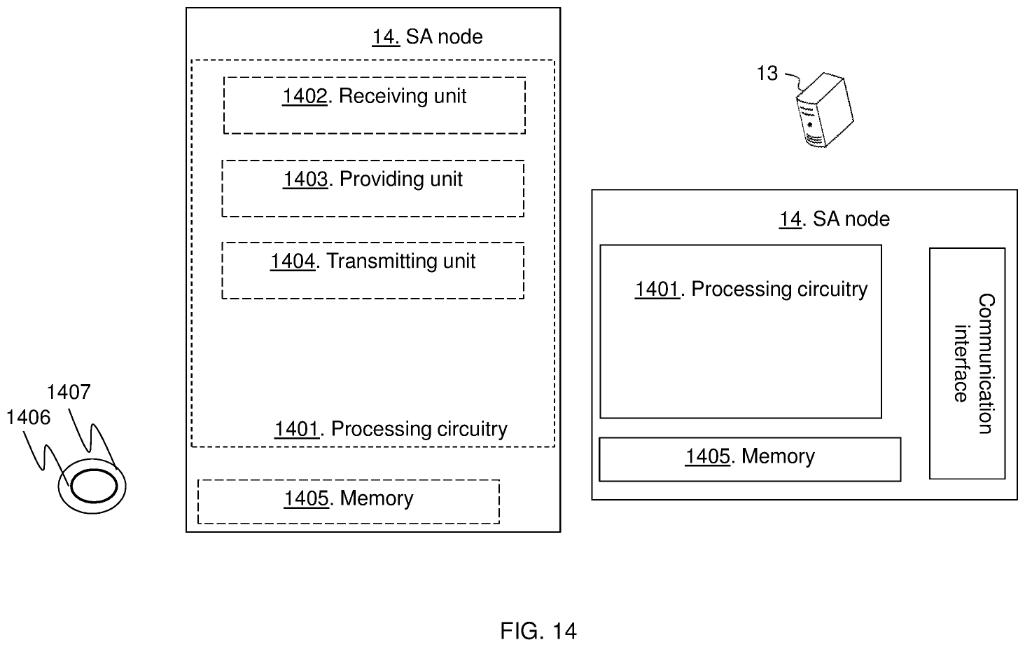

FIG. 14 is a block diagram depicting the SA node 14 for handling a communication in a communication network according to embodiments herein.

The SA node 14 may comprise processing circuitry 1401, e.g. one or more processors, configured to perform the methods herein.

The SA node may comprise a receiving unit 1402, e.g. a receiver or transceiver. The SA node, the processing circuitry 1401, and/or the receiving unit 1402 is configured to receive, from the CN node 13, the indication of the detected upcoming event affecting the service provided to the UE 10 served by the SA node 14.

The SA node 14 may comprise a providing unit 1403. The SA node 14, the processing circuitry 1401, and/or the providing unit 1403 is configured to provide the service to the UE 10, taking the indication into account or informing the UE 10 of the upcoming event.

The SA node 14 may comprise a transmitting unit 1404, e.g. a transmitter or transceiver. The SA node 14, the processing circuitry 1401, and/or the transmitting unit 1404 may be configured to transmit the indication of the detected upcoming event, to the UE 10, upon receiving the indication of the detected upcoming event from the CN node 13.

The SA node 14 further comprises a memory 1405. The memory 1405 comprises one or more units to be used to store data on, such as radio signals, sequences of sequence of linear and nonlinear functions and symbols, data such as radio signals, events, indication, data such as services, configuration, input/output data, metadata, etc. and applications to perform the methods disclosed herein when being executed, and similar. The SA node 14 may further comprise a communication interface comprising e.g. one or more antenna or antenna elements.

The methods according to the embodiments described herein for the SA node 14 are respectively implemented by means of e.g. a computer program product 1406 or a computer program, comprising instructions, i.e., software code portions, which, when executed on at least one processor, cause the at least one processor to carry out the actions described herein, as performed by the SA node 14. The computer program product 1406 may be stored on a computer-readable storage medium 1407, e.g. a disc, a USB stick or similar. The computer-readable storage medium 1407, having stored thereon the computer program product, may comprise the instructions which, when executed on at least one processor, cause the at least one processor to carry out the actions described herein, as performed by the SA node 14. In some embodiments, the computer-readable storage medium may be a transitory or a non-transitory computer-readable storage medium.

In some embodiments a more general term “radio network node” is used and it can correspond to any type of radio-network node or any network node, which communicates with a wireless device and/or with another network node. Examples of network nodes are gNodeB, eNodeB, NodeB, MeNB, SeNB, a network node belonging to Master cell group (MCG) or Secondary cell group (SCG), base station (BS), multi-standard radio (MSR) radio node such as MSR BS, eNodeB, network controller, radio-network controller (RNC), base station controller (BSC), relay, donor node controlling relay, base transceiver station (BTS), access point (AP), transmission points, transmission nodes, Remote radio Unit (RRU), Remote Radio Head (RRH), nodes in distributed antenna system (DAS), etc.

In some embodiments the non-limiting term wireless device or user equipment (UE) is used and it refers to any type of wireless device communicating with a network node and/or with another wireless device in a cellular or mobile communication system. Examples of UE are target device, device to device (D2D) UE, proximity capable UE (aka ProSe UE), machine type UE or UE capable of machine to machine (M2M) communication, Tablet, mobile terminals, smart phone, laptop embedded equipped (LEE), laptop mounted equipment (LME), USB dongles etc.

Embodiments are applicable to any radio access technology (RAT) or multi-RAT systems, where the devices receives and/or transmit signals, e.g. data, such as New Radio (NR), W-Fi, Long Term Evolution (LTE), LTE-Advanced, Wideband Code Division Multiple Access (WCDMA), Global System for Mobile communications/enhanced Data rate for GSM Evolution (GSM/EDGE), Worldwide Interoperability for Microwave Access (WiMax), or Ultra Mobile Broadband (UMB), just to mention a few possible implementations.

As will be readily understood by those familiar with communications design, that functions means or circuits may be implemented using digital logic and/or one or more microcontrollers, microprocessors, or other digital hardware. In some embodiments, several or all of the various functions may be implemented together, such as in a single application-specific integrated circuit (ASIC), or in two or more separate devices with appropriate hardware and/or software interfaces between them. Several of the functions may be implemented on a processor shared with other functional components of a wireless device or network node, for example.

Alternatively, several of the functional elements of the processing units discussed may be provided through the use of dedicated hardware, while others are provided with hardware for executing software, in association with the appropriate software or firmware. Thus, the term “processor” or “controller” as used herein does not exclusively refer to hardware capable of executing software and may implicitly include, without limitation, digital signal processor (DSP) hardware and/or program or application data. Other hardware, conventional and/or custom, may also be included. Designers of communications devices will appreciate the cost, performance, and maintenance trade-offs inherent in these design choices.

It will be appreciated that the foregoing description and the accompanying drawings represent non-limiting examples of the methods and apparatus taught herein. As such, the apparatus and techniques taught herein are not limited by the foregoing description and accompanying drawings. Instead, the embodiments herein are limited only by the following claims and their legal equivalents.

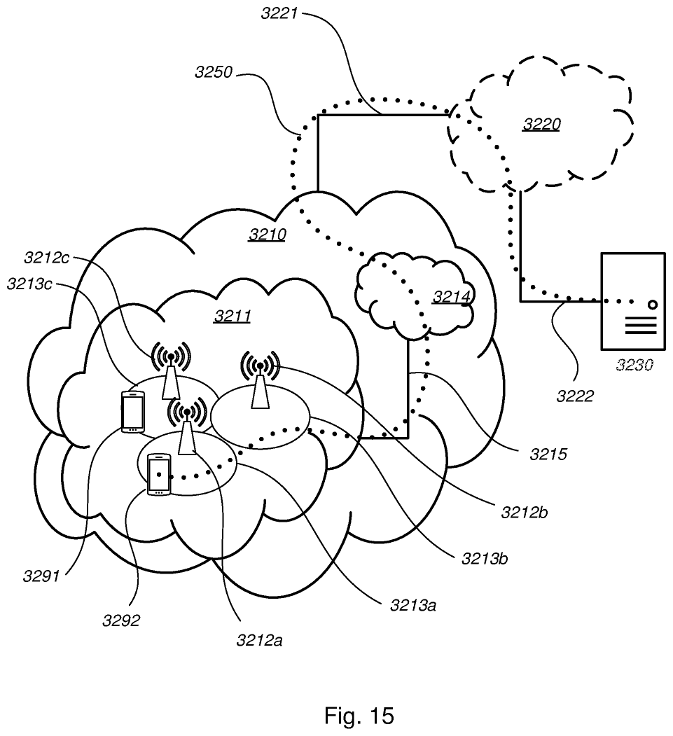

FIG. 15 shows a Telecommunication network connected via an intermediate network to a host computer in accordance with some embodiments. With reference to FIG. 15, in accordance with an embodiment, a communication system includes telecommunication network 3210, such as a 3GPP-type cellular network, which comprises access network 3211, such as a radio access network, and core network 3214. Access network 3211 comprises a plurality of base stations 3212a, 3212b, 3212c, such as NBs, eNBs, gNBs or other types of wireless access points being examples of the radio network node 12 above, each defining a corresponding coverage area 3213a, 3213b, 3213c. Each base station 3212a, 3212b, 3212c is connectable to core network 3214 over a wired or wireless connection 3215. A first UE 3291 located in coverage area 3213c is configured to wirelessly connect to, or be paged by, the corresponding base station 3212c. A second UE 3292 in coverage area 3213a is wirelessly connectable to the corresponding base station 3212a. While a plurality of UEs 3291, 3292 are illustrated in this example being examples of the wireless device 10 above, the disclosed embodiments are equally applicable to a situation where a sole UE is in the coverage area or where a sole UE is connecting to the corresponding base station 3212.

Telecommunication network 3210 is itself connected to host computer 3230, which may be embodied in the hardware and/or software of a standalone server, a cloud-implemented server, a distributed server or as processing resources in a server farm. Host computer 3230 may be under the ownership or control of a service provider, or may be operated by the service provider or on behalf of the service provider. Connections 3221 and 3222 between telecommunication network 3210 and host computer 3230 may extend directly from core network 3214 to host computer 3230 or may go via an optional intermediate network 3220. Intermediate network 3220 may be one of, or a combination of more than one of, a public, private or hosted network; intermediate network 3220, if any, may be a backbone network or the Internet; in particular, intermediate network 3220 may comprise two or more sub-networks (not shown).

The communication system of FIG. 15 as a whole enables connectivity between the connected UEs 3291, 3292 and host computer 3230. The connectivity may be described as an over-the-top (OTT) connection 3250. Host computer 3230 and the connected UEs 3291, 3292 are configured to communicate data and/or signaling via OTT connection 3250, using access network 3211, core network 3214, any intermediate network 3220 and possible further infrastructure (not shown) as intermediaries. OTT connection 3250 may be transparent in the sense that the participating communication devices through which OTT connection 3250 passes are unaware of routing of uplink and downlink communications. For example, base station 3212 may not or need not be informed about the past routing of an incoming downlink communication with data originating from host computer 3230 to be forwarded (e.g., handed over) to a connected UE 3291. Similarly, base station 3212 need not be aware of the future routing of an outgoing uplink communication originating from the UE 3291 towards the host computer 3230.

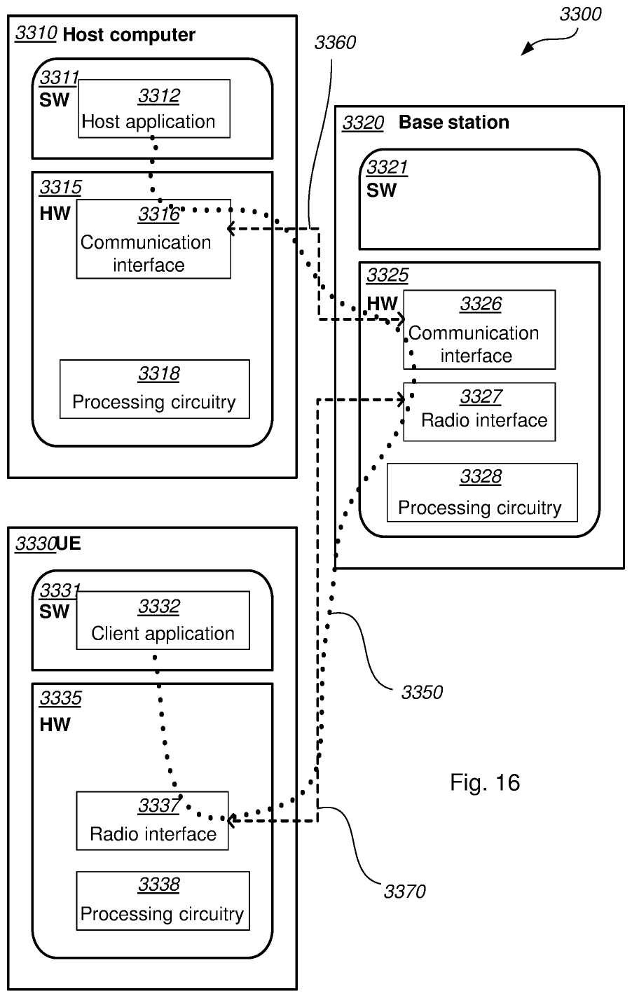

FIG. 16 shows a host computer communicating via a base station and with a user equipment over a partially wireless connection in accordance with some embodiments

Example implementations, in accordance with an embodiment, of the UE, base station and host computer discussed in the preceding paragraphs will now be described with reference to FIG. 16. In communication system 3300, host computer 3310 comprises hardware 3315 including communication interface 3316 configured to set up and maintain a wired or wireless connection with an interface of a different communication device of communication system 3300. Host computer 3310 further comprises processing circuitry 3318, which may have storage and/or processing capabilities. In particular, processing circuitry 3318 may comprise one or more programmable processors, application-specific integrated circuits, field programmable gate arrays or combinations of these (not shown) adapted to execute instructions. Host computer 3310 further comprises software 3311, which is stored in or accessible by host computer 3310 and executable by processing circuitry 3318. Software 3311 includes host application 3312. Host application 3312 may be operable to provide a service to a remote user, such as UE 3330 connecting via OTT connection 3350 terminating at UE 3330 and host computer 3310. In providing the service to the remote user, host application 3312 may provide user data which is transmitted using OTT connection 3350.

Communication system 3300 further includes base station 3320 provided in a telecommunication system and comprising hardware 3325 enabling it to communicate with host computer 3310 and with UE 3330. Hardware 3325 may include communication interface 3326 for setting up and maintaining a wired or wireless connection with an interface of a different communication device of communication system 3300, as well as radio interface 3327 for setting up and maintaining at least wireless connection 3370 with UE 3330 located in a coverage area (not shown in FIG. 16) served by base station 3320. Communication interface 3326 may be configured to facilitate connection 3360 to host computer 3310. Connection 3360 may be direct or it may pass through a core network (not shown in FIG. 16) of the telecommunication system and/or through one or more intermediate networks outside the telecommunication system. In the embodiment shown, hardware 3325 of base station 3320 further includes processing circuitry 3328, which may comprise one or more programmable processors, application-specific integrated circuits, field programmable gate arrays or combinations of these (not shown) adapted to execute instructions. Base station 3320 further has software 3321 stored internally or accessible via an external connection.

Communication system 3300 further includes UE 3330 already referred to. Its hardware 3333 may include radio interface 3337 configured to set up and maintain wireless connection 3370 with a base station serving a coverage area in which UE 3330 is currently located. Hardware 3333 of UE 3330 further includes processing circuitry 3338, which may comprise one or more programmable processors, application-specific integrated circuits, field programmable gate arrays or combinations of these (not shown) adapted to execute instructions. UE 3330 further comprises software 3331, which is stored in or accessible by UE 3330 and executable by processing circuitry 3338. Software 3331 includes client application 3332. Client application 3332 may be operable to provide a service to a human or non-human user via UE 3330, with the support of host computer 3310. In host computer 3310, an executing host application 3312 may communicate with the executing client application 3332 via OTT connection 3350 terminating at UE 3330 and host computer 3310. In providing the service to the user, client application 3332 may receive request data from host application 3312 and provide user data in response to the request data. OTT connection 3350 may transfer both the request data and the user data. Client application 3332 may interact with the user to generate the user data that it provides.

It is noted that host computer 3310, base station 3320 and UE 3330 illustrated in FIG. 16 may be similar or identical to host computer 3230, one of base stations 3212a, 3212b, 3212c and one of UEs 3291, 3292 of FIG. 15, respectively. This is to say, the inner workings of these entities may be as shown in FIG. 16 and independently, the surrounding network topology may be that of FIG. 15.

In FIG. 16, OTT connection 3350 has been drawn abstractly to illustrate the communication between host computer 3310 and UE 3330 via base station 3320, without explicit reference to any intermediary devices and the precise routing of messages via these devices. Network infrastructure may determine the routing, which it may be configured to hide from UE 3330 or from the service provider operating host computer 3310, or both. While OTT connection 3350 is active, the network infrastructure may further take decisions by which it dynamically changes the routing (e.g., on the basis of load balancing consideration or reconfiguration of the network).

Wireless connection 3370 between UE 3330 and base station 3320 is in accordance with the teachings of the embodiments described throughout this disclosure. One or more of the various embodiments improve the performance of OTT services provided to UE 3330 using OTT connection 3350, in which wireless connection 3370 forms the last segment. More precisely, the teachings of these embodiments may increase the performance of the UE knowing the upcoming event and thus leading to a better responsiveness and less energy consumption.

A measurement procedure may be provided for the purpose of monitoring data rate, latency and other factors on which the one or more embodiments improve. There may further be an optional network functionality for reconfiguring OTT connection 3350 between host computer 3310 and UE 3330, in response to variations in the measurement results. The measurement procedure and/or the network functionality for reconfiguring OTT connection 3350 may be implemented in software 3311 and hardware 3315 of host computer 3310 or in software 3331 and hardware 3333 of UE 3330, or both. In embodiments, sensors (not shown) may be deployed in or in association with communication devices through which OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of OTT connection 3350 may include message format, retransmission settings, preferred routing etc.; the reconfiguring need not affect base station 3320, and it may be unknown or imperceptible to base station 3320. Such procedures and functionalities may be known and practiced in the art. In certain embodiments, measurements may involve proprietary UE signaling facilitating host computer 3310's measurements of throughput, propagation times, latency and the like. The measurements may be implemented in that software 3311 and 3331 causes messages to be transmitted, in particular empty or ‘dummy’ messages, using OTT connection 3350 while it monitors propagation times, errors etc.

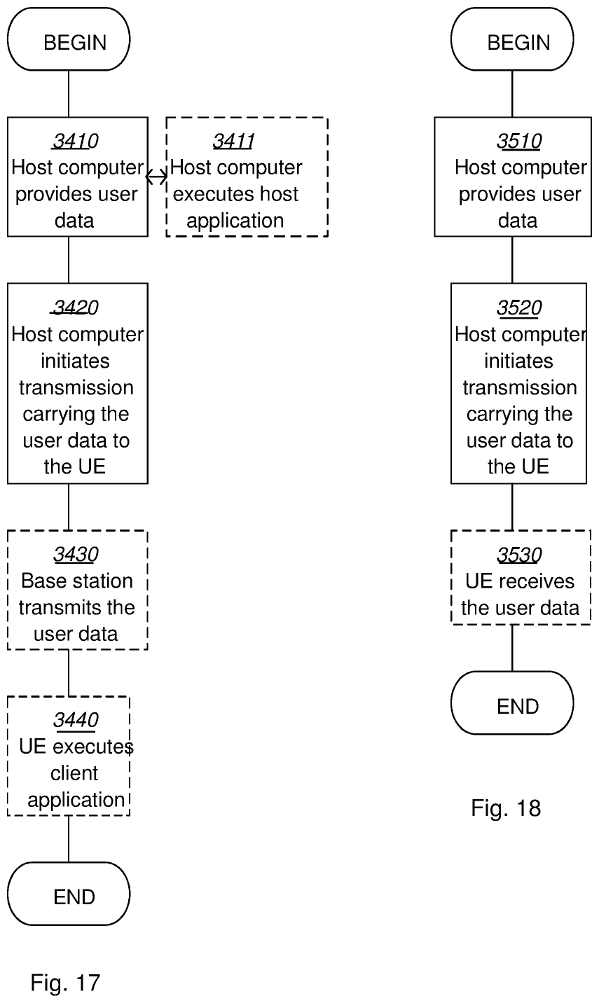

FIG. 17 shows methods implemented in a communication system including a host computer, a base station and a user equipment in accordance with some embodiments.

FIG. 17 is a flowchart illustrating a method implemented in a communication system, in accordance with one embodiment. The communication system includes a host computer, a base station and a UE which may be those described with reference to FIG. and FIG. 16. For simplicity of the present disclosure, only drawing references to FIG. 17 will be included in this section. In step 3410, the host computer provides user data. In substep 3411 (which may be optional) of step 3410, the host computer provides the user data by executing a host application. In step 3420, the host computer initiates a transmission carrying the user data to the UE. In step 3430 (which may be optional), the base station transmits to the UE the user data which was carried in the transmission that the host computer initiated, in accordance with the teachings of the embodiments described throughout this disclosure. In step 3440 (which may also be optional), the UE executes a client application associated with the host application executed by the host computer.

FIG. 18 shows methods implemented in a communication system including a host computer, a base station and a user equipment in accordance with some embodiments.

FIG. 18 is a flowchart illustrating a method implemented in a communication system, in accordance with one embodiment. The communication system includes a host computer, a base station and a UE which may be those described with reference to FIG. and FIG. 16. For simplicity of the present disclosure, only drawing references to FIG. 18 will be included in this section. In step 3510 of the method, the host computer provides user data. In an optional substep (not shown) the host computer provides the user data by executing a host application. In step 3520, the host computer initiates a transmission carrying the user data to the UE. The transmission may pass via the base station, in accordance with the teachings of the embodiments described throughout this disclosure. In step 3530 (which may be optional), the UE receives the user data carried in the transmission.

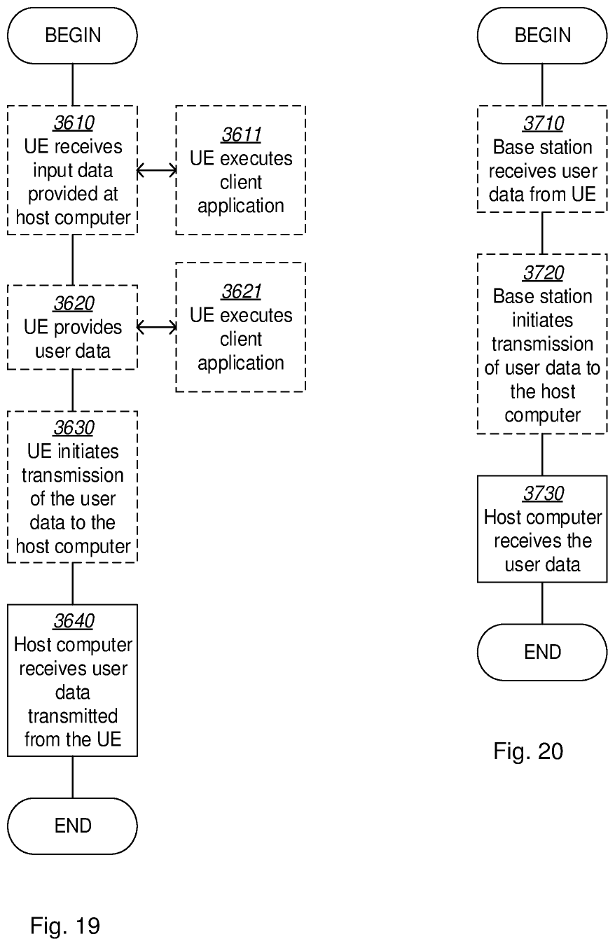

FIG. 19 shows methods implemented in a communication system including a host computer, a base station and a user equipment in accordance with some embodiments.

FIG. 19 is a flowchart illustrating a method implemented in a communication system, in accordance with one embodiment. The communication system includes a host computer, a base station and a UE which may be those described with reference to FIG. and FIG. 16. For simplicity of the present disclosure, only drawing references to FIG. 19 will be included in this section. In step 3610 (which may be optional), the UE receives input data provided by the host computer. Additionally or alternatively, in step 3620, the UE provides user data. In substep 3621 (which may be optional) of step 3620, the UE provides the user data by executing a client application. In substep 3611 (which may be optional) of step 3610, the UE executes a client application which provides the user data in reaction to the received input data provided by the host computer. In providing the user data, the executed client application may further consider user input received from the user. Regardless of the specific manner in which the user data was provided, the UE initiates, in substep 3630 (which may be optional), transmission of the user data to the host computer. In step 3640 of the method, the host computer receives the user data transmitted from the UE, in accordance with the teachings of the embodiments described throughout this disclosure.

FIG. 20 show methods implemented in a communication system including a host computer, a base station and a user equipment in accordance with some embodiments.

FIG. 20 is a flowchart illustrating a method implemented in a communication system, in accordance with one embodiment. The communication system includes a host computer, a base station and a UE which may be those described with reference to FIG. and FIG. 16. For simplicity of the present disclosure, only drawing references to FIG. 20 will be included in this section. In step 3710 (which may be optional), in accordance with the teachings of the embodiments described throughout this disclosure, the base station receives user data from the UE. In step 3720 (which may be optional), the base station initiates transmission of the received user data to the host computer. In step 3730 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

It will be appreciated that the foregoing description and the accompanying drawings represent non-limiting examples of the methods and apparatus taught herein. As such, the apparatus and techniques taught herein are not limited by the foregoing description and accompanying drawings. Instead, the embodiments herein are limited only by the following claims and their legal equivalents.

1. A method performed by a Radio Access Network (RAN) node for handling a communication in a communication network, the method comprising:
detecting an upcoming event based on whether a condition is fulfilled or not, wherein the condition is related to a connection between the RAN node and a User Equipment (UE) served by the RAN node; and
providing to the UE or an application associated with the UE, an indication of the detected upcoming event.

2. The method of claim 1, wherein the indication is transmitted to the UE.

3. The method of claim 1, wherein the indication is transmitted to a Core Network (CN) node.

4. The method of claim 1, wherein the indication is transmitted using a Radio Resource Control, RRC, message, to the UE.

5. The method of claim 1, wherein the detected upcoming event comprises one or more of the following: initiating a handover for the UE; a loss of connectivity; a change of data rate; when a signal-to-noise ratio is below a threshold value; or a change to a target cell that belongs to another RAN.

6. A method performed by a User Equipment (UE) for handling a communication in a communication network, the method comprising:
receiving, from a Radio Access Network (RAN) node, or internally, an indication of a detected upcoming event affecting a connection between the RAN node and the UE served by the RAN node; and
performing communication taking the indication into account.

7. The method of claim 6, wherein the indication is received using a Radio Resource Control message, from the RAN node.

8. The method of claim 6, wherein an Operating System (OS) of the UE is informed of the indication over an application programming interface and wherein the OS informs an application of the UE of the indication.

9. The method of claim 6, wherein the method further comprises:
receiving from a Server Application node the indication of the detected upcoming event via the RAN node.

10. The method of claim 6, wherein the indication of the detected upcoming event is received by a Client Application of the UE.

11. The method of claim 6, wherein performing communication taking the indication into account comprises adjusting behaviour of the UE based on the indication.

12. A method performed by a Core Network (CN) node for handling a communication in a communication network, the method comprising:
receiving, from a Radio Access Network (RAN) node, an indication of a detected upcoming event affecting a connection between the RAN node and a User Equipment (UE) served by the RAN node; and
transmitting the same or another indication of the detected upcoming event, towards a Server Application node associated with the UE.

13. A method performed by a Server Application (SA) node for handling a communication in a communication network, the method comprising:
receiving, from a Core Network (CN) node, an indication of a detected upcoming event affecting a service provided to a User Equipment UE, (UE) served by the SA node; and
providing the service to the UE taking the indication into account or informing the UE of the upcoming event.

14. The method of claim 13, wherein upon receiving the indication of a detected upcoming event, transmitting the indication of the detected upcoming event, to the UE.

15-30. (canceled)
